(19) United States
(12) Patent Application Publication
(10) Pub. No.: US 2016/0133255 A1
(43) Pub. Date: May 12, 2016

(54) VOICE TRIGGER SENSOR

(71) Applicant: DSP Group LTD., Herzeliya (IL)

(72) Inventor: Moshe Haiut, Ramat Gan (IL)

(21) Appl. No.: 14/938,878

(22) Filed: Nov. 12, 2015

Related U.S. Application Data
(60) Provisional application No. 62/078,428, filed on Nov. 12, 2014.

(51) Int. Cl. G10L 15/22; H04R 19/00; G10L 15/06

(52) U.S. Cl. CPC G10L 15/22; G10L 15/063; H04R 19/005; G10L 2015/223; G10L 2015/0638; H04R 2201/003

(57) ABSTRACT

A method for voice triggering, the method may include coupling, by an interface of a voice trigger sensor, the voice trigger sensor to a computer; receiving, by the voice trigger sensor, from the computer configuration information; configuring the voice trigger sensor by using the configuration information; coupling, by the interface, the voice trigger sensor to a target device during a voice activation period; receiving, by a processor of the voice trigger sensor, during the voice activation period, input signals; applying, by the processor, on the input signals a voice activation process to detect a voice command; and

at least partially participating in an execution of the voice command.

### RELATED APPLICATIONS

This application claims priority from U.S. provisional patent Ser. No. 62/078,428 filing date Nov. 12, 2014, which is incorporated in its entirety.

### BACKGROUND

Many electronic smart devices use Automatic Speech Recognition (ASR) technology as a means for entering voice commands and control phrases. For example, users may operate the Internet browser on their mobile device by speaking pre-defined audio commands (e.g. “Siri” tool which uses the Internet “cloud” to perform ASR). This usage mode of smart devices is expected to further develop to a level that will enable smart machines to fully understand and react to natural continuous user's speech.

A special usage mode of ASR is what is called Voice Triggering (VT) or Voice Activation (VA)—a speech recognition technology that is intended to activate a device or wake it up from its sleep mode via a pre-defined user's voice command. This technology differs from conventional existing Speech Recognition (SR) solutions in that it is limited in power consumption and computing power so as to meet the requirement that it should be operating while the system is in its power down mode. On the other hand, in oppose to the ASR tool, VT and VA are programmed to recognize a single specific phrase or a limited number of phrases that are pre-defined by vendor.

Huge efforts were invested in making ASR, VT, and VA algorithms insensitive to speech source—or what is called “speaker independent”. This means that most Speech Recognition applications in smart devices are designed to be able to recognize the speech of any user with no need for pre-training (old solutions required to do some pre-training, where the specific user was asked to repeat saying certain given phrases several times).

### SUMMARY

According to an embodiment of the invention there may be provided a method for voice triggering, the method may include coupling, by an interface of a voice trigger sensor, the voice trigger sensor to a computer; receiving, by the voice trigger sensor, from the computer configuration information; configuring the voice trigger sensor by using the configuration information; coupling, by the interface, the voice trigger sensor to a target device during a voice activation period; receiving, by a processor of the voice trigger sensor, during the voice activation period, input signals; applying, by the processor, on the input signals a voice activation process to detect a voice command; and at least partially participating in an execution of the voice command.

The applying of the voice activation process may include applying user independent voice activation.

The coupling of the voice trigger sensor to the computer may occur during a training period; wherein the configuration information metadata may include a training result that may be generated by the computer during the training period; wherein the applying of the voice activation process may include applying, by the processor, on the input signals a training based voice activation process while using the training result to detect the voice command.

The method may include generating, by a microphone of the voice trigger sensor, first detection signals, during the training period, in response to first audio signals outputted by a user; sending, by the interface the detection signals to the computer; and generating, by the microphone the input signals during the voice activation period.

The method may include receiving the input signals from the target device.

The method may include wirelessly coupling the voice trigger sensor to at least one of the computer and the target device.

The method may include detacheably connecting the voice trigger sensor to at least one of the computer and the target device.

The method may include operating the voice trigger sensor in a first power consuming mode before detecting the voice command and to operating the voice trigger sensor in a second power consuming mode in response to the detection of the voice command; and wherein a power consumption related to the second power consuming mode exceeds the power consumption related to the first power consuming mode.

According to an embodiment of the invention there may be provided a voice trigger sensor that may include an interface, a memory module, a power supply module, and a processor; wherein the interface may be adapted to couple the voice trigger sensor to a computer and to receive configuration information; wherein the voice trigger sensor may be adapted to be configured in response to the configuration information; wherein the interface may be adapted to couple the voice trigger sensor to a target device during a voice activation period; wherein the processor may be adapted to: receive, during the voice activation period, input signals; apply on the input signals an voice activation process while using the configuration information to detect a voice command; and at least partially participate in an execution of the voice command.

The processor may be adapted to apply on the input signals a user independent voice recognition process.

The configuration information may include a training result; wherein the training result may be obtained during a training period and while the voice trigger sensor is coupled by the interface to the computer.

The processor may be adapted to apply on the input signals a user dependent voice recognition process while using the training result.

The voice trigger sensor may include a microphone; wherein the microphone may be adapted to generate first detection signals, during the training period, in response to first audio signals outputted by a user; wherein the interface may be adapted to send the detection signals to the computer; and wherein the microphone may be adapted to generate the input signals during the voice activation period.

The voice trigger sensor may not include a microphone and the interface may be configured to receive the input signals from the target device.

The interface may be adapted to wirelessly couple the voice trigger sensor to at least one of the computer and the target device.

The interface may be adapted to be detacheably connected to at least one of the computer and the target device.

The voice trigger sensor that may be adapted to operate in a first power consuming mode before the processor detects the voice command and to operate in a second power consuming mode in response to the detection of the voice command; and wherein a power consumption related to the second power consuming mode exceeds the power consumption related to the first power consuming mode.

The interface may be adapted to receive configuration information from the computer; and wherein the processor may be adapted to configure the training based voice activation process in response to the configuration information.

The interface may be adapted to receive configuration information from the computer; wherein the voice trigger sensor may include a microphone; and wherein the voice trigger sensor may be adapted to configure the microphone of the voice activated device in response to the configuration information.

A non-transitory computer readable medium that stores instructions that once executed by a voice trigger sensor cause the voice trigger sensor to: couple, by an interface of a voice trigger sensor, the voice trigger sensor to a computer; receive, by the voice trigger sensor, from the computer configuration information; configure the voice trigger sensor by using the configuration information; couple, by the interface, the voice trigger sensor to a target device during a voice activation period; receive, by a processor of the voice trigger sensor, during the voice activation period, input signals; apply, by the processor, on the input signals a voice activation process to detect a voice command; and at least partially participate in an execution of the voice command.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a voice trigger sensor according to an embodiment of the invention;

FIG. 1B illustrates a voice trigger sensor according to an embodiment of the invention;

FIG. 1C illustrates a voice trigger sensor according to an embodiment of the invention;

FIG. 1D illustrates a voice trigger sensor according to an embodiment of the invention;

FIG. 1E illustrates a voice trigger sensor according to an embodiment of the invention;

FIG. 1F illustrates a voice trigger sensor according to an embodiment of the invention;

FIG. 2A illustrates a voice trigger sensor and computers according to an embodiment of the invention;

FIG. 2B illustrates a voice trigger sensor and computers according to an embodiment of the invention;

FIG. 3 illustrates a snapshot of a screen of a voice trigger configuration program according to an embodiment of the invention;

FIG. 4 illustrates a voice trigger sensor and various target devices according to an embodiment of the invention;

FIG. 5A illustrates a learning process according to an embodiment of the invention;

FIG. 5B illustrates a voice recognition process according to an embodiment of the invention;

FIG. 6 illustrates a method according to an embodiment of the invention; and

FIG. 7 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The terms “voice recognition”, “voice activation” and “voice triggering” are used in an interchangeable manner.

The term “voice trigger sensor” is a sensor that is configured to detect one or more predefined voice commands and to react to the detection of any of the one ore more predefined voice commands.

According to various embodiments of the invention there may be provided methods, flash memory controllers and non-transitory computer readable media for voice triggering. A voice trigger sensor detects user commands using training results obtained during a training period. The training result is generated by a computer that is coupled to a voice trigger sensor during the training period.

The voice trigger sensor does not include the resources required to perform the training process and thus can be compact and cheap. Non-limiting examples of the dimensions for a voice trigger sensor (disregarding the wired interface) are 4 millimeters by 2 millimeters by 2 millimeters.

The voice trigger sensor may apply, using the training result, a training based voice trigger process—thus benefiting from the increased accuracy of training based voice trigger processes without paying the penalty (additional resources) associated with the execution of the training process.

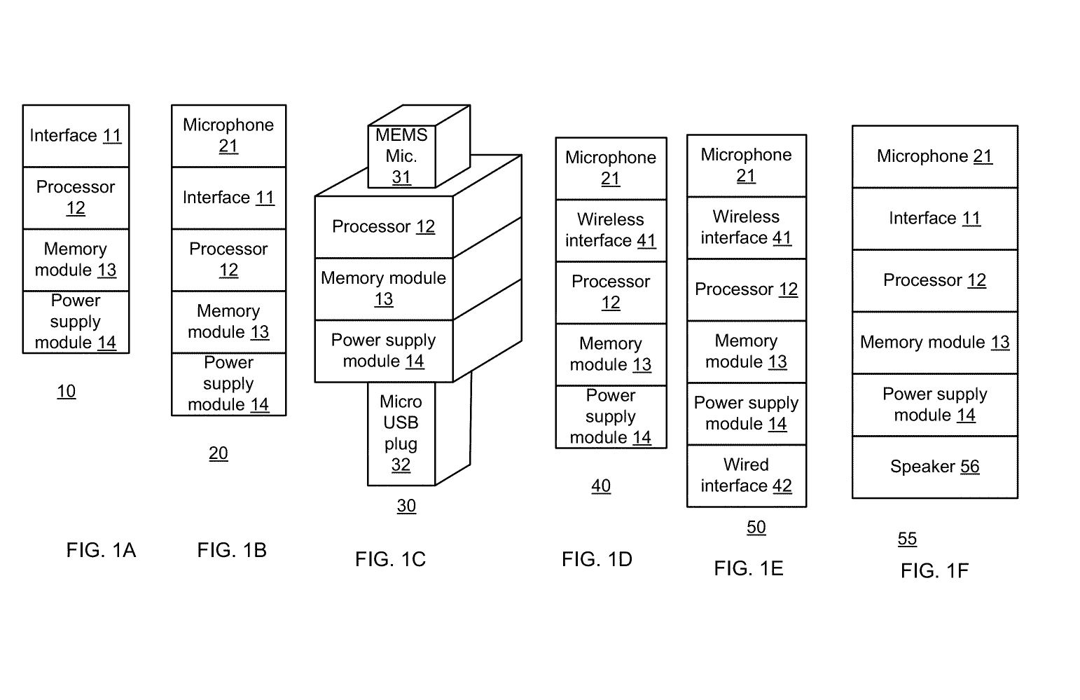

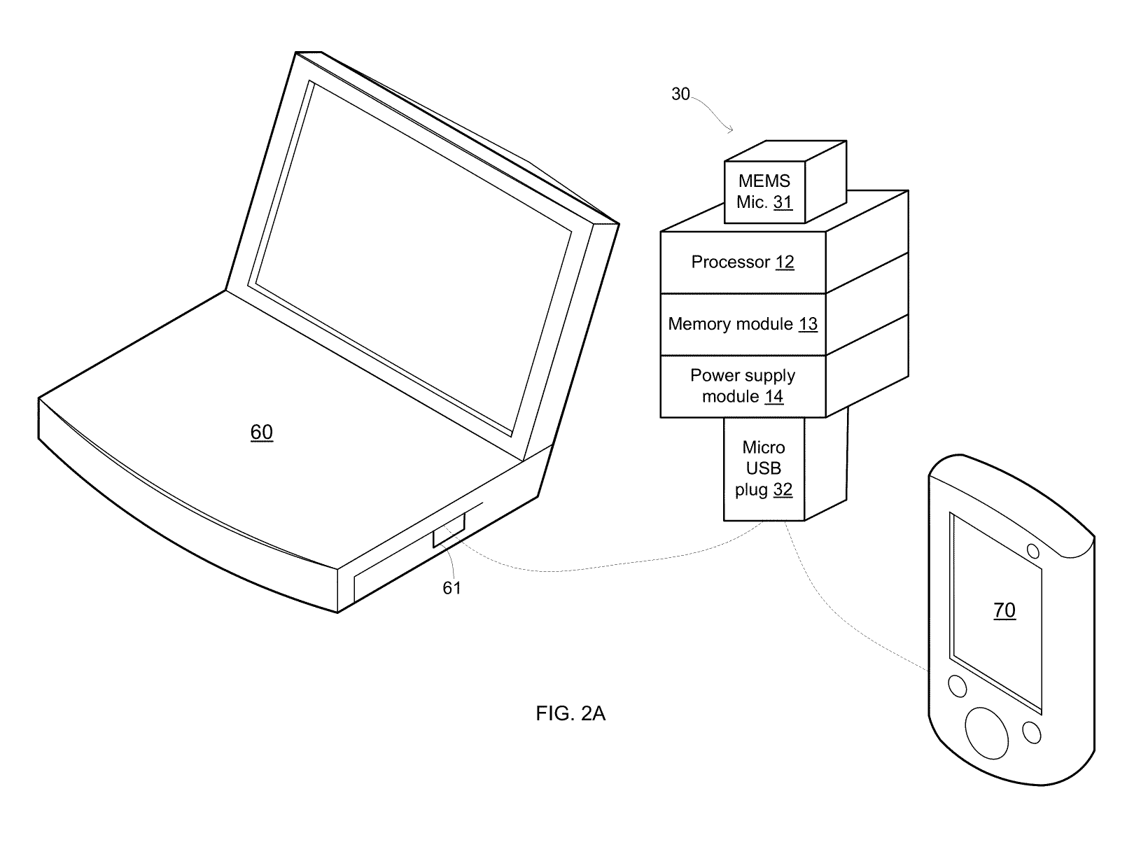

FIG. 1A illustrates a voice trigger sensor 10 according to an embodiment of the invention.

The voice trigger sensor 10 includes interface 11, memory module 13, power supply module 14, and a processor 12.

The interface 11 may be configured to couple the voice trigger sensor 10 to a computer during a training period. The training process may occur during the training period. The training process may include requesting the user to read out one or more voice commands that will later be detected during the voice activation period.

The interface 11 may be configured to couple the voice trigger sensor to a target device during a voice activation period. During the voice activation period the voice trigger sensor 10 applies a training-based voice trigger process to detect voice commands.

The memory module 13 may be configured to receive from the computer (that executed the training process) a training result that is generated by the computer during the training period.

According to an embodiment of the invention, memory module 13 may store an acoustic model database. The acoustic model database may be loaded, by the user, from the Internet and may assist when the voice trigger sensor performs a speaker-independent voice commands set.

Additionally or alternatively, the acoustic model database may be the training result generated by the computer as result of the training process.

The processor 12 may be configured to receive, during the voice activation period, input signals. The input signals may be audio signals generated by a user (including but not limited to a voice command, speech or other voices that are not voice commands).

The processor 12 may be configured to apply on the input signals a training based voice activation process while using the training result to detect a voice command.

The processor 12 may be configured to at least partially participate in an execution of the voice command. The at least partially participation may include relaying or otherwise sending the voice command to the target device, generating an alert to the user and/or to the target device, allocate processing resources to the execution of the voice command, and the like.

The voice trigger sensor may participate in the execution of a detected voice command by sending a request to the target device to receive information (for example the exact time), receive the information from the target device and then generate an indication (audio and/or visual) about the information received from the target device. It is noted that any cooperation between the target device and the voice trigger sensor may be provided. The target device and the voice trigger sensor may exchange commands, audio signals, video signals, metadata and/or any other type of information.

According to an embodiment of the invention the voice trigger sensor 10 may operate in a low power mode (also referred to as idle mode) during the voice activation period—and until detecting a voice command. Once a voice command is detected (or once input signals to be processed by the processor are detected) the voice trigger sensor may increase its power consumption in order to process the input signals and/or participate in the execution of the voice command (when detected)—and then return to the low power mode.

Any known method of power management may be applied by the voice trigger sensor 10. Low power mode may involve a power consumption of few Mili-Amperes, or otherwise power consumption that allows to be fed from a battery during long periods (months, years).

According to an embodiment of the invention the voice trigger sensor 10 may receive, during the training period or outside the training period, configuration information. The configuration information may differ from the training result and/or may include the training result. The configuration information may be provided by the computer.

Voice trigger sensor 10 may not include a microphone. In this case the voice trigger sensor 10 may use the microphone of the computer during the training period and/or may use the microphone of the target device during the voice activation period. In the latter case the input signals processed by the processor 12 may be provided from the microphone of the target device.

According to an embodiment of the invention the voice trigger sensor has a microphone.

FIG. 1B illustrates a voice trigger sensor 20 according to an embodiment of the invention.

Voice trigger sensor 20 of FIG. 1B differs from voice trigger sensor 10 of FIG. 1A by including a microphone. 21

Microphone 21 i configured to generate first detection signals, during the training period, in response to first audio signals outputted by a user.

Interface 11 may be configured to send the detection signals to the computer.

Microphone may be configured to generate the input signals during the voice activation period.

FIG. 1C illustrates a voice trigger sensor 30 according to an embodiment of the invention.

In voice trigger sensor 30 the interface is a micro USB plug 32, the microphone is a MEMS microphone (“MEMS Mic.”) 31. The processor may be an ASIC, FPGA or any type of hardware processor.

The memory module 13 may include a non-volatile memory unit for storing the training result (for example—configuration and Acoustic Model(s) used for the training based voice recognition process) and software executed by the processor 12. The memory module may include a volatile memory. The volatile memory may store, for example, the input signals from the microphone.

MEMS microphone 31 is used for capturing the user's voice both for training and during the Always On operation (during the voice detection period). Any other type of microphone (including NEMS microphone or non-MEMS microphone) may be used.

The micro USB plus can be replaced by any other connector. For example—a connector the detacheably connects voice trigger sensor 30 to at least one of the computer and the target device.

Using standard connectors may increase the usability of the voice trigger sensor.

FIG. 1D illustrates a voice trigger sensor 40 according to an embodiment of the invention.

The voice trigger sensor 40 includes an interface that is a wireless interface 41.

Wireless interface 41 may be configured to wirelessly couple the voice trigger sensor to at least one of the computer and the target device.

FIG. 1E illustrates a voice trigger sensor 50 according to an embodiment of the invention.

The voice trigger sensor 50 includes a wireless interface 41 and a wired interface 42. Using both types of interfaces may expand the range of computers and target devices that may be connected to the voice trigger sensor 50. The wired interface 42 may detacheably connect the voice trigger sensor 50 to the computer and/or to the target device.

FIG. 1F illustrates a voice trigger sensor 55 according to an embodiment of the invention.

Voice trigger sensor 55 includes a speaker 56.

Any one of the voice trigger sensor s of FIGS. 1A-1E may include a speaker.

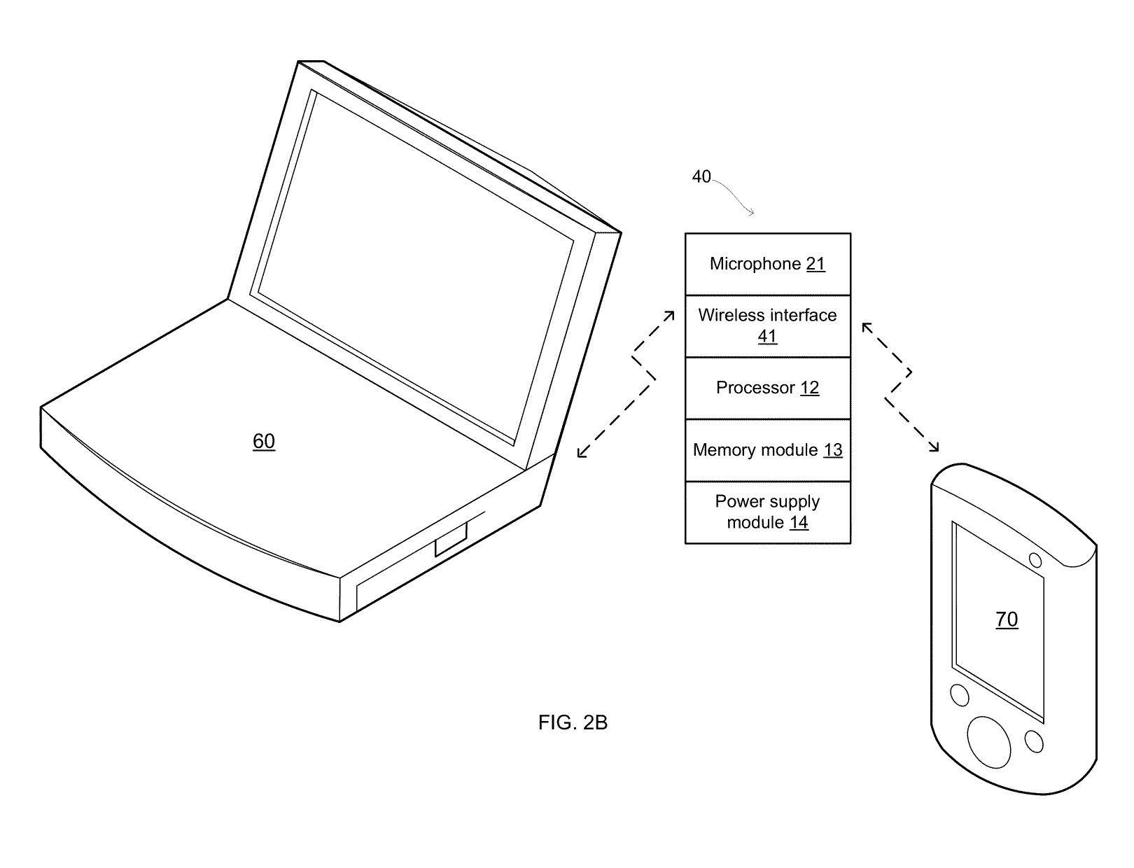

FIG. 2A illustrates voice trigger sensor 30 that may be connected during the training period, by micro USB plug 32 to a computer such as a laptop computer 60 or a smartphone 70.

FIG. 2B illustrates voice trigger sensor 30 that may be wirelessly coupled during the training period, by wireless interface 41 to a computer such as a laptop computer 60 or a smartphone 70. Any type of wireless connection or protocol may be used. Non-limiting examples include Bluetooth™, WiFi™, Zig-bee™ and the like.

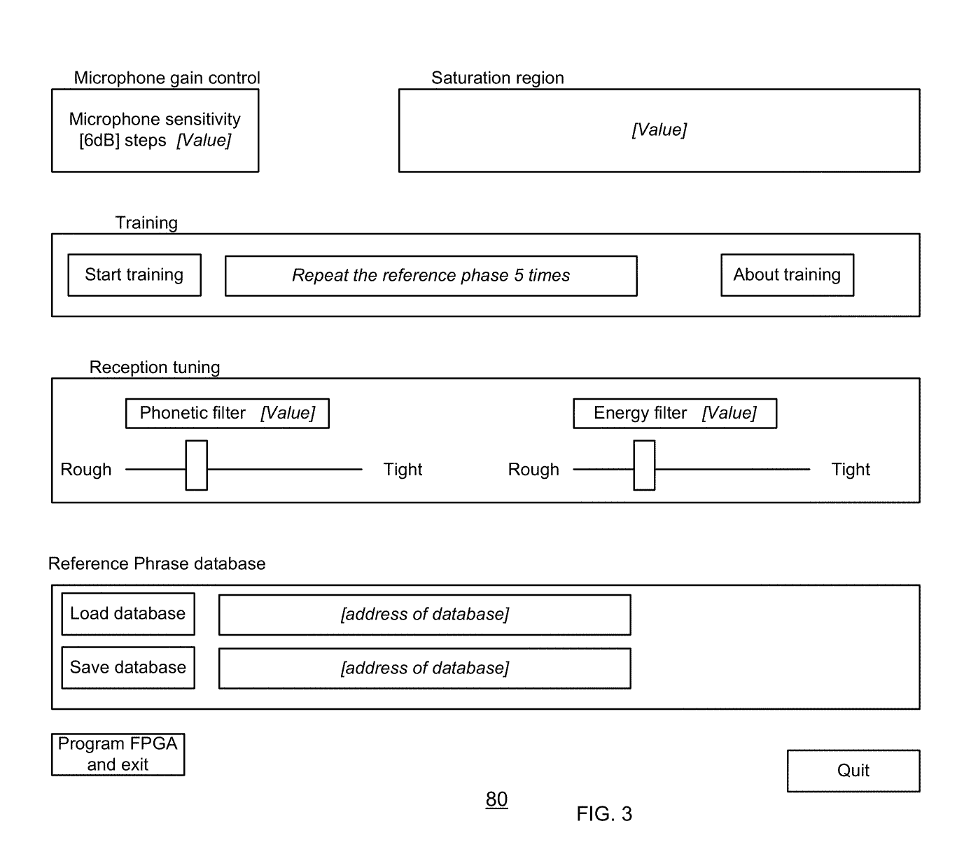

FIG. 3 illustrates a snapshot 80 of a screen of a voice trigger configuration program according to an embodiment of the invention

The screen is used (via the computer) to configure or train the voice trigger sensor 10.

Such an application interacts with the user to enable adjustment of sensor sensitivity and trigger decision threshold, so as to meet the conditions in which the user intends to have the voice trigger sensor operate. Not shown in FIG. 6 is the capability to download and program the voice trigger sensor with pre-defined database that is intended for a speaker-independent command set.

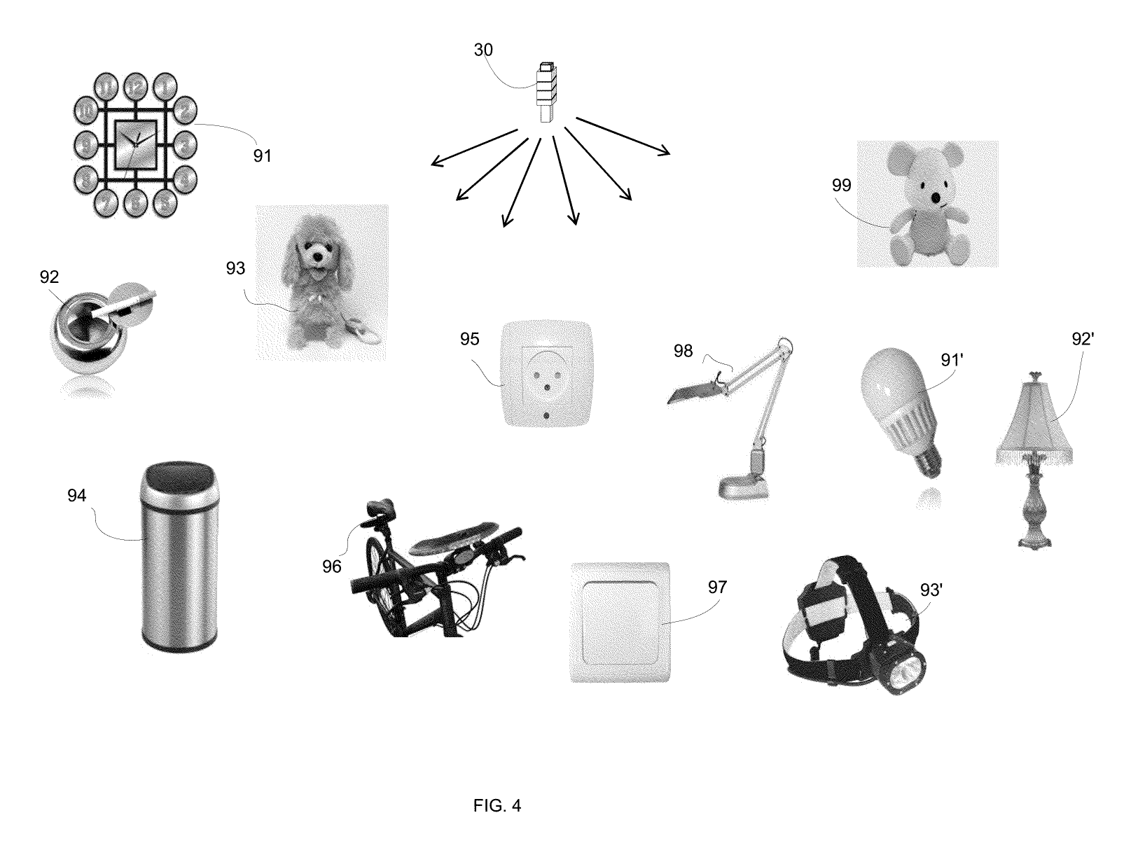

FIG. 4 illustrates a voice trigger sensor 30 and various target devices such as target devices 91, 92, 93, 94, 95, 96, 97, 98, 99, 91′, 92′ and 93′ according to an embodiment of the invention;

Voice trigger sensor 30 may be coupled to any of the target devices and detect a voice command aimed to the target devices.

The target devices include, for example, wall-watch 91 that is an example of an ultra-low-power device (which also does not have the capability to interact with the user for configuration and training). The night lamp 92′ is an example for a device with unlimited power supply.

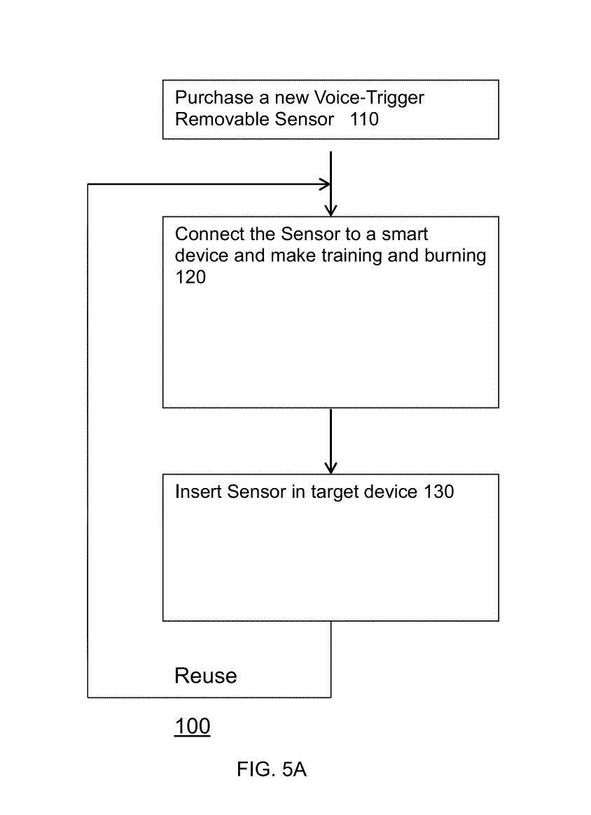

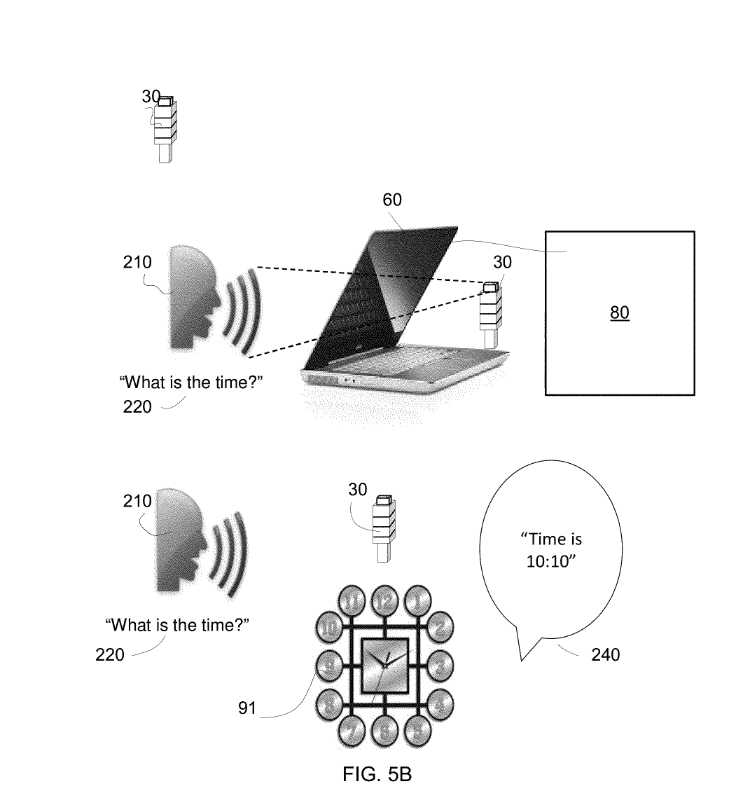

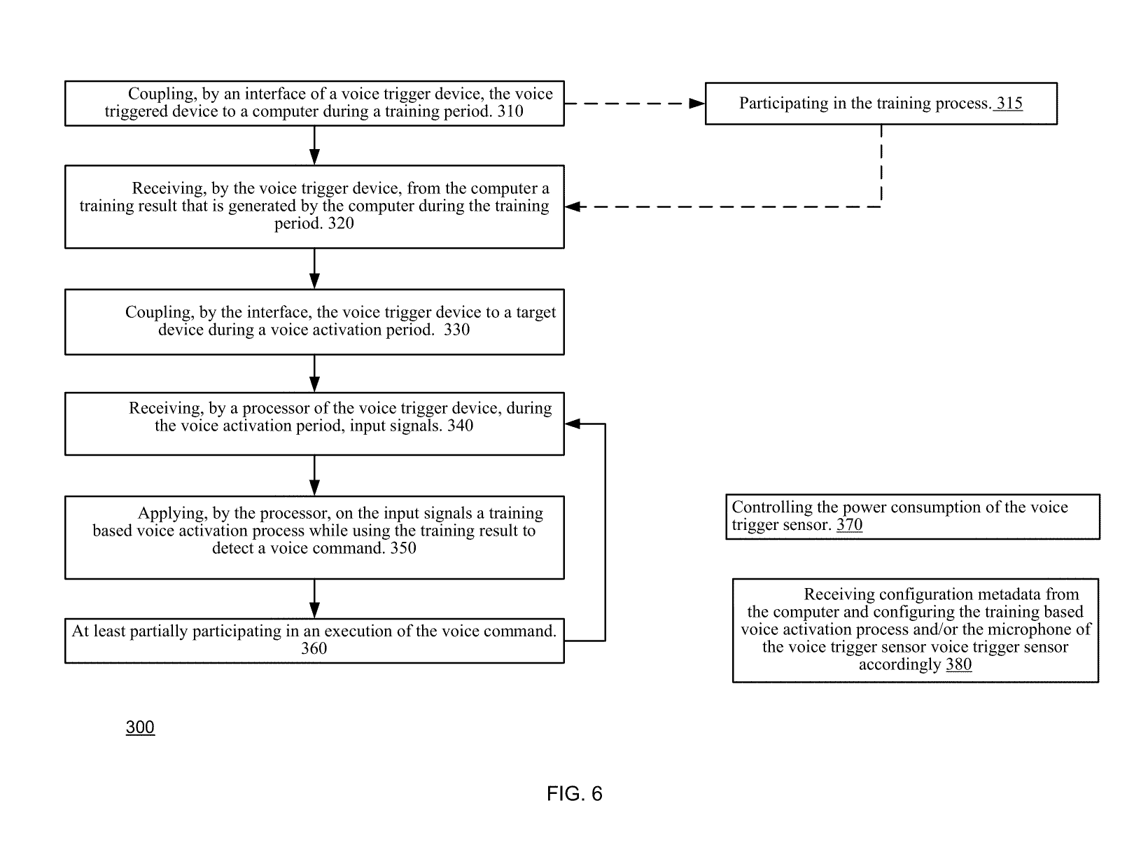

FIGS. 5A and 5B demonstrate the process of training the Voice-Trigger sensor using a laptop and a standard application with GUI, and then using the voice trigger sensor in an Always On mode to have a wall-watch 91 say the time of day when asked to, according to an embodiment of the invention.

FIG. 5A illustrates a process 100 that includes purchasing a new voice trigger sensor 110, connecting the voice trigger sensor to a computer (smart device), performing a training process and storing (burning) the training result at the voice trigger sensor 120, and inserting the voice trigger sensor 30 in the target device 130.

FIG. 5B illustrates a training process during which the in which the voice trigger sensor 30 is connected to laptop computer 60 and the user 210 speaks the voice command “what is the time” 220. The laptop computer 60 generates a training result that is sent to voice trigger sensor 30 and will allow the voice trigger sensor 30 to recognize the command “what is the time” 220.

FIG. 5B also illustrates a training based voice recognition process during which the voice trigger sensor 30 is connected to the wall-watch 91 and recognized the voice command “what is the time” 220 issued by the user. The voice trigger sensor 30 connects to the wall-watch 91 to obtain the time and may generate, using a speaker of the wall-watch or the voice trigger sensor 30 to generate the response 230 “time is 10:10” (assuming that the wall-watch 91 indicates that the time is 10:10).

FIG. 6 illustrates method 300 according to an embodiment of the invention.

Method 300 may include a sequence of steps 310, 320, 330, 340, 350 and 360, Step 360 may be followed by step 340.

Step 310 may include coupling, by an interface of a voice trigger sensor, the voice trigger sensor to a computer during a training period.

Step 320 may include receiving, by the voice trigger sensor, from the computer a training result that is generated by the computer during the training period.

Step 330 may include coupling, by the interface, the voice trigger sensor to a target device during a voice activation period.

Step 340 may include receiving, by a processor of the voice trigger sensor, during the voice activation period, input signals.

Step 350 may include applying, by the processor, on the input signals a training based voice activation process while using the training result to detect a voice command.

Step 360 may include at least partially participating in an execution of the voice command.

Step 310 may be followed by step 315 of participating in the training process. Step 315 may include generating, by a microphone of the voice trigger sensor, first detection signals, during the training period, in response to first audio signals outputted by a user and sending, by the interface the detection signals to the computer.

Step 340 may be preceded by step 332 of generating, by the microphone the input signals during the voice activation period.

Alternatively, step 340 may be preceded by step 334 of receiving the input signals from the target device.

Method 300 may include step 370 of controlling the power consumption of the voice trigger sensor.

Step 370 may include increasing the power consumption voice trigger sensor when receiving input signals (step 340) or when detecting the voice command (350).

Step 370 may include reducing the power consumption when the input signals are not voice commands or after executing step 360.

Method 300 may include step 380 of receiving configuration information from the computer and configuring the training based voice activation process and/or the microphone of the voice trigger sensor voice trigger sensor accordingly.

The configuration information may be provided during step 320 but this is not necessarily so.

The voice trigger sensor may have other form-factors than that of the example. For instance, it may be built-in in the target device (e.g. to save the cost of the USB plug), configured (trained) via an existing USB plug in the target device or via a wireless link (WiFi, Bluetooth, etc). A special case is when the device is a device of IOT (Internet Of Things) when the configuration (or training) can be done from a computer or a smartphone via the Internet connection. When connected to a target device having wireless capabilities the Voice-Trigger sensor may utilize the wireless capabilities of the target device and may allow wireless voice training in Voice-Trigger sensor s that do not include wireless communication circuits.

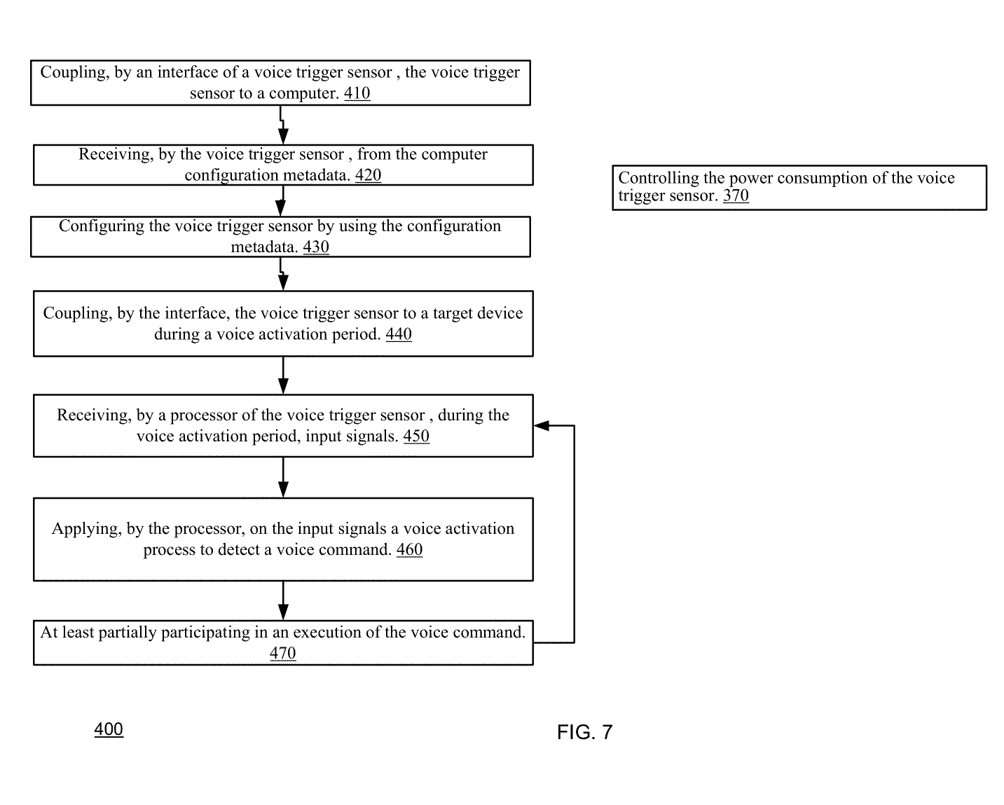

FIG. 7 illustrates method 400 according to an embodiment of the invention.

Method 400 may start by step 410 of coupling, by an interface of a voice trigger sensor, the voice trigger sensor to a computer.

The coupling may be wireless coupling or wired coupling.

Step 410 may be followed by step 420 of receiving, by the voice trigger sensor, from the computer configuration information. The configuration information may be a training result or may differ from a training result.

The configuration information may be provided by a user via an interaction with a computer. For example the configuration information may include, for example, the language of the voice command (language may be selected by the user), specific appliance (target device) to be controlled, voice commands to be sensed by the voice trigger sensor, and the like.

The voice trigger sensor may include an interface for receiving the configuration information.

Step 420 may be followed by step 430 of configuring the voice trigger sensor by using the configuration information. The configuration may include any type of configuration including but not limited to configuring software modules, hardware modules, storing audio modules to be used during voice recognition, and the like. The configuring may be applied by a processor of the voice trigger sensor or any other components of the voice trigger sensor.

Step 430 may be followed by step 440 of coupling, by the interface, the voice trigger sensor to a target device during a voice activation period. The coupling may be wireless coupling or wired coupling.

Step 440 may be followed by step 450 of receiving, by a processor of the voice trigger sensor, during the voice activation period, input signals. The input signals may be provided by a microphone of the voice trigger sensor. Alternatively, the input signals may be sensed by a microphone of the target device and fed via an interface of the voice trigger sensor to the processor or the memory unit of the voice trigger sensor.

Step 450 may be followed by step 460 of applying, by the processor, on the input signals a voice activation process to detect a voice command.

Step 460 may be followed by step 470 of at least partially participating in an execution of the voice command.

Method 400 may include step 370.

The applying of the voice activation process may include applying user independent voice activation.

Alternatively, the applying of the voice activation process may include applying user dependent voice activation. In this case the configuration information may include a training result.

Also, if the target device already contains a microphone then the built-in voice trigger sensor can be of a reduced price using the microphone from the target device.

There may be provided a voice trigger sensor that contains Mic, ASIC, Flash; a Removable Voice-Trigger Sensor that contains Mic, ASIC, Flash. The voice trigger sensor may store and use a speaker independent voice recognition database.

The voice trigger sensor may store and use a speaker dependent voice recognition database.

The voice trigger sensor may be programmable (configurable) by a Wireless link. There may be provided a voice trigger sensor that is built-in in the target device.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations, and alternatives are also possible. The specifications and drawings are, accordingly, to be regarded in an illustrative rather than in a restrictive sense.

The word “comprising” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

We claim:

1. A method for voice triggering, the method comprises:
coupling, by an interface of a voice trigger sensor, the voice trigger sensor to a computer;
receiving, by the voice trigger sensor, from the computer configuration information;
configuring the voice trigger sensor by using the configuration information;
coupling, by the interface, the voice trigger sensor to a target device during a voice activation period;
receiving, by a processor of the voice trigger sensor, during the voice activation period, input signals;
applying, by the processor, on the input signals a voice activation process to detect a voice command; and
at least partially participating in an execution of the voice command.

2. The method according to claim 1 wherein the applying of the voice activation process comprises applying user independent voice activation.

3. The method according to claim 1 wherein the coupling of the voice trigger sensor to the computer occurs during a training period;
wherein the configuration information metadata comprises a training result that is generated by the computer during the training period;
wherein the applying of the voice activation process comprises applying, by the processor, on the input signals a training based voice activation process while using the training result to detect the voice command.

4. The method according to claim 3, comprising generating, by a microphone of the voice trigger sensor, first detection signals, during the training period, in response to first audio signals outputted by a user;
sending, by the interface the detection signals to the computer; and
generating, by the microphone the input signals during the voice activation period.

5. The method according to claim 1, comprising receiving the input signals from the target device.

6. The method according to claim 1, comprising wirelessly coupling the voice trigger sensor to at least one of the computer and the target device.

7. The method according to claim 1, comprising detacheably connecting the voice trigger sensor to at least one of the computer and the target device.

8. The method according to claim 1, comprising operating the voice trigger sensor in a first power consuming mode before detecting the voice command and to operating the voice trigger sensor in a second power consuming mode in response to the detection of the voice command; and
wherein a power consumption related to the second power consuming mode exceeds the power consumption related to the first power consuming mode.

9. A voice trigger sensor comprising an interface, a memory module, a power supply module, and a processor;
wherein the interface is adapted to couple the voice trigger sensor to a computer and to receive configuration information;
wherein the voice trigger sensor is adapted to be configured in response to the configuration information;
wherein the interface is adapted to couple the voice trigger sensor to a target device during a voice activation period;
wherein the processor is configured to:
(i) receive, during the voice activation period, input signals;
(ii) apply on the input signals an voice activation process while using the configuration information to detect a voice command; and
(iii) at least partially participate in an execution of the voice command.

10. The voice trigger sensor according to claim 9 wherein the processor is adapted to apply on the input signals a user independent voice recognition process.

11. The voice trigger sensor according to claim 9, wherein the configuration information comprising a training result; wherein the training result is obtained during a training period and while the voice trigger sensor is coupled by the interface to the computer.

12. The voice trigger sensor according to claim 11, wherein the processor is adapted to apply on the input signals a user dependent voice recognition process while using the training result.

13. The voice trigger sensor according to claim 11, comprising a microphone;
wherein the microphone is configured to generate first detection signals, during the training period, in response to first audio signals outputted by a user;
wherein the interface is configured to send the detection signals to the computer; and
wherein the microphone is configured to generate the input signals during the voice activation period.

14. The voice trigger sensor according to claim 9, wherein the voice trigger sensor does not include a microphone; and wherein the interface is configured to receive the input signals from the target device.

15. The voice trigger sensor according to claim 9, wherein the interface is configured to wirelessly couple the voice trigger sensor to at least one of the computer and the target device.

16. The voice trigger sensor according to claim 9, wherein the interface is configured to be detacheably connected to at least one of the computer and the target device.

17. The voice trigger sensor according to claim 9, that is configured to operate in a first power consuming mode before the processor detects the voice command and to operate in a second power consuming mode in response to the detection of the voice command; and
wherein a power consumption related to the second power consuming mode exceeds the power consumption related to the first power consuming mode.

18. The voice trigger sensor according to claim 9, wherein the interface is configured to receive configuration information from the computer; and wherein the processor is configured to configure the training based voice activation process in response to the configuration information.

19. The voice trigger sensor according to claim 9, wherein the interface is configured to receive configuration information from the computer; wherein the voice trigger sensor comprises a microphone; and wherein the voice trigger sensor is configured to configure the microphone of the voice activated device in response to the configuration information.

20. A non-transitory computer readable medium that stores instructions that once executed by a voice trigger sensor cause the voice trigger sensor to: couple, by an interface of a voice trigger sensor, the voice trigger sensor to a computer; receive, by the voice trigger sensor, from the computer configuration information; configure the voice trigger sensor by using the configuration information; couple, by the interface, the voice trigger sensor to a target device during a voice activation period; receive, by a processor of the voice trigger sensor, during the voice activation period, input signals; apply, by the processor, on the input signals a voice activation process to detect a voice command; and at least partially participate in an execution of the voice command.
